(19) United States
(12) Patent Application Publication
(10) Pub. No.: US 2019/0106180 A1
(43) Pub. Date: Apr. 11, 2019

(54) Mooring hook

(71) Applicant: Robert D. Jeschke, Dayton, OH (US)

(72) Inventor: Robert D. Jeschke, Dayton, OH (US)

(21) Appl. No.: 15/727,573

(22) Filed: Oct. 7, 2017

(51) Int. Cl. B63B 21/54; B63B 21/04; F16B 45/02; F16B 7/10

(52) U.S. Cl. CPC B63B 21/54; F16B 7/10; F16B 45/025; B63B 21/04

(57) ABSTRACT

A mooring hook includes a telescoping pole having a first end for grasping and second end which is U-shaped serving as a hook, a flange is connected to and extends radially inward from the pole and axially upward from the second end and has an eyelet therein. Provided is a clip of a size to permit part thereof to be received through the eyelet and a mooring line is connected at one end to the clip. A slidable selectable fixable clamp is connected to the telescoping pole between the first end and the flange and includes a loop opening sufficiently large and receiving the mooring line therethrough wherein a second end of the mooring line is free for connection to a cleat of a boat.

### BACKGROUND OF INVENTION

### Field of Invention

The present invention relates generally to the field docking boats. More particularly, the invention relates to a mooring hook design which is used for docking a boat.

### Prior Art

There are numerous prior existing devices for assisting in docking boats. These include for example the use of a poll having a hook on its end. Typically, the docking is a boat is assisted with the use of mooring lines which can be use with the hook.

The prior art is improved upon with the instant invention which eases the use of such prior devices and simplifies the docking process.

### SUMMARY OF THE INVENTION

An object of the invention is to provide a mooing hook which will facilitate docking of a boat.

Another object is to provide a telescopically extendable handle for a mooring hook which includes flange having an eyelet for either a line or D lock clasp at one end and an axially adjustably connected loop for the pole handle.

A further object of the invention is to provide a mooring hook which is extremely simple to use and inexpensive to manufacture.

Other objects and advantages will be apparent during the course of the following description.

Accordingly, the invention is directed to a mooring hook. The mooring hook includes a telescoping pole which is preferably twist locking/releasing. One end of the pole includes a handle and another end is U-shaped having a fixed flange extending radially inward from the second end and has an eyelet therein. The flange, pole and U-shaped end lie in a common plane. A carabiner clip or the like is of a size to permit part of the structure thereof to be received through the eyelet. A mooring line is connected at one end to the carabiner clip. A slidable selectable fixable clamp can be provided to connected to the pole between the handle and the flange and includes a loop opening sufficiently large to enable the mooring line to be received therethrough. A second end of the mooring line can be connected to a cleat on the boat.

Together, these components provide an easy to use mooring hook for docking a boat.

### BRIEF DESCRIPTION OF THE DRAWINGS

In the accompanying drawings, forming a part of this application, and in which like numerals are used to designate like parts throughout the same:

FIG. 1A is a perspective view of a mooring hook of the invention.

FIG. 1B is a perspective view of another embodiment mooring hook of the invention.

FIG. 2 depicts a typical dock pole used in mooring a boat.

FIG. 3 is a top perspective view illustrating the storage placement of a mooring hook of the invention behind the seat of a boat.

FIG. 4 is a perspective view illustrating the removal and extension of the mooring hook of the invention making ready for mooring.

FIG. 5 is a perspective view illustrating the placement of the mooring hook on a pole.

FIG. 6 is a perspective view illustrating the docking of the boat with the mooring hook on the pole.

### DETAILED DESCRIPTION OF THE PREFERRED EMBODIMENTS

Referring in detail to the drawings, the mooring hook of the present invention is generally designated by the number 10. The mooring hook 10 of the present invention which includes a telescoping cylindrical pole 12 which has a handle 14. The handle 14 is can be a rubber like material formed to be gripped in the hands of a person who may be a deck hand on a boat B.

The telescoping cylindrical pole 12 includes multiple segments 12A, 12B and 12C which expand to a maximum length of less than 10 feet and contract to shortest length of about 3.5 feet. The multiple segments 12A, 12B and 12C are thus provided with an incrementally reduced diameter, respectively to provide a telescoping nature. It is contemplated that the lengths can be varied slight to carry out the instant invention. Attached to the segment 12C is a U-shaped end 16 preferably integrally formed or connected. The U-shaped end 16 can have a width span of between 4 to 12 inches, and the inventor's preferred width span is about 10 inches. The U-shaped end 16 has a flange 18 extending radially preferably inwardly in a same plane as the U-shaped end 16 and has an eyelet 20 formed therein. In this way, the mooring hook 10 can be easily stored behind and between the seat S of the boat B and inside panel IP of the boat B which typically provides minimal clearance as depicted in FIG. 3 with the U-shaped end 16 up and the segments 12A, 12B and 12C lying on the deck of the boat B.

A carabiner clip 22 is sized to be received through the eyelet 20 and retained on the flange 18. A mooring line or docking rope 24 is provided having a first end 26 in a fixed loop for easy connection to the carabiner clip 22. The docking rope 24 has a second end 28 which remains free for use as later described. The docking rope 24 can be ⅜″, ½″, ⅝″ where the diameter varies with the size of the boat B and is easily received onto the carabiner clip 22.

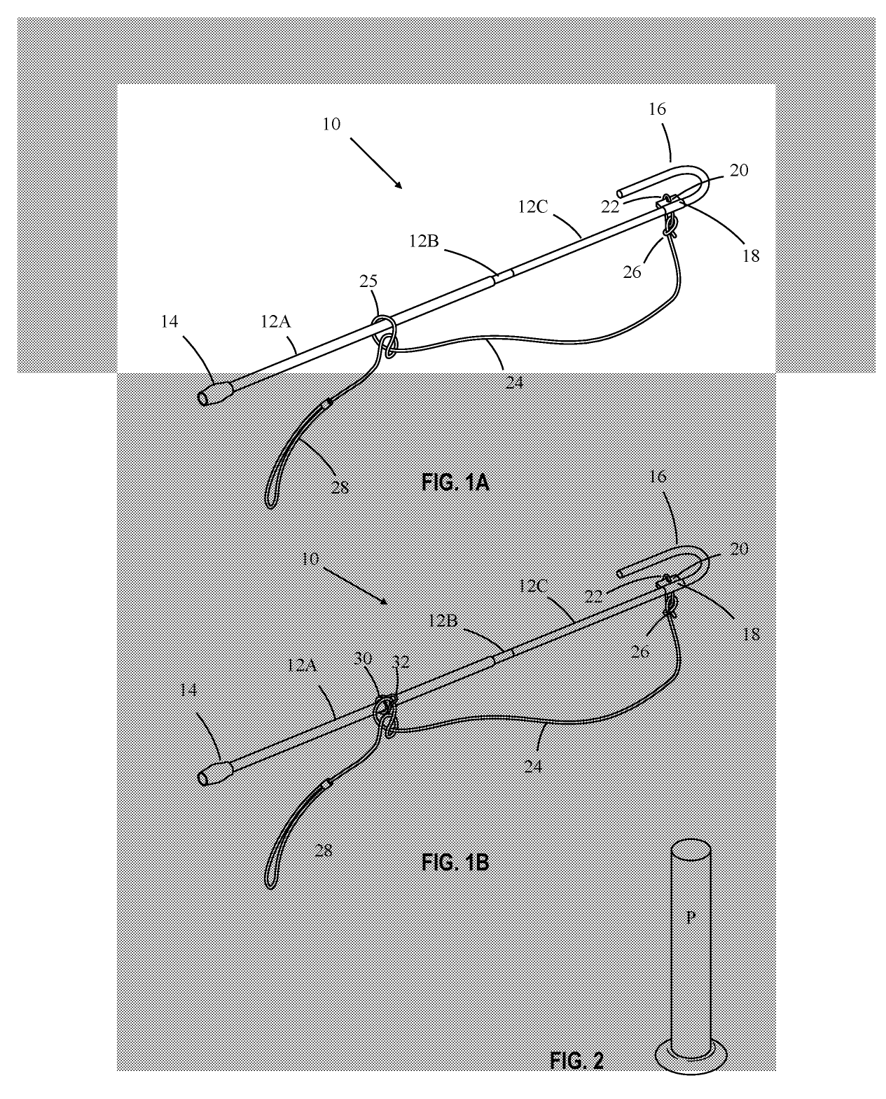

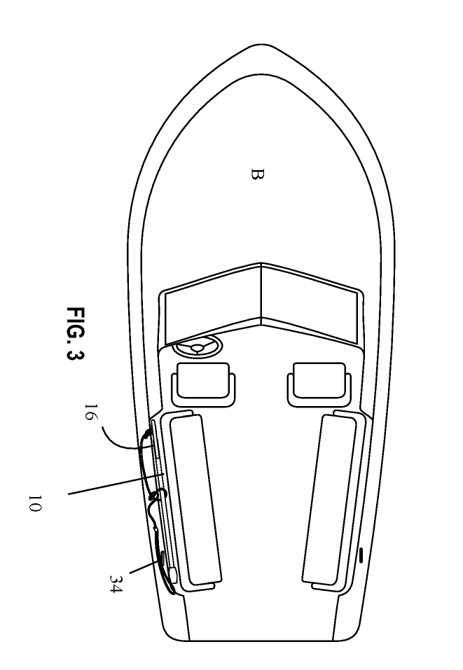

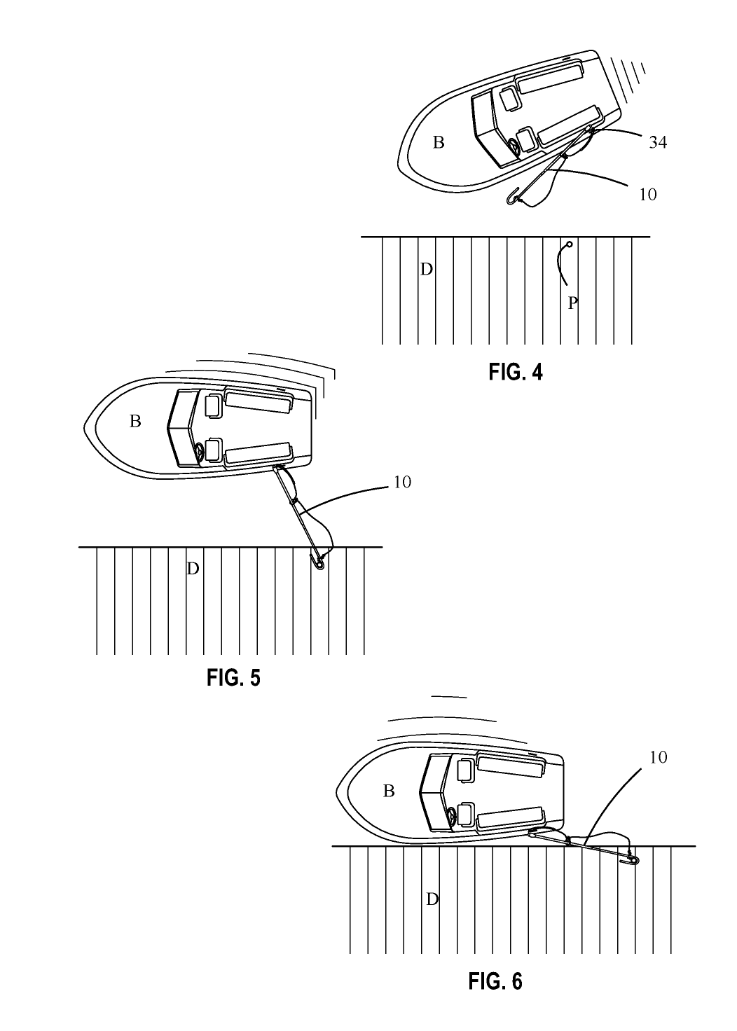

A loop 25 can be formed on the rope 24 as illustrated in FIG. 1A or a slidable selectable fixable clamp 30 (as seen in FIG. 1B) is connected to the telescoping pole 12 between the handle 14 and the flange 18 and includes a loop 32 with an opening sufficiently large to enable the docking rope 24 to be received therethrough. The second end 28 can be connected to a cleat 34 on a boat B.

The U-shaped end 16 is used to facilitate the engagement of the mooring hook 10 for hooking about a dock post P with a mooring line 26. When pulling the boat B up to a dock D, one standing on the stern of the boat B can hook the dock post P. The length of the telescoping pole 12 can be adjusted prior to or during docking.

Additionally, the slidable selectable fixable clamp 30 can be positioned real time in docking the boat B as desired to provide the appropriate holding distance and angle of the telescoping pole 12 from the dock post P to assure not only holding the boat B in position but also assure the mooring hook 10 does not fall from its position about the docking post P. The second end 28 of the docking top 24 can be tied to cleat 34. Unlike prior devices, slack is minimized through the use of the instant invention by virtue of the dynamically rigid yet adjustable length.

The boat B is now held and one can throttle up the boat B with the mooring hook 10 in place and held by rope 24 such that the stern of the boat B is held and the movement of the bow of the boat B can easily be brought to dock under idle power.

From the foregoing, it is apparent that there has been provided a mooring hook 10 which will facilitate the handling of a mooring of a boat B. By so providing, a single user can easily dock the boat B. With the present invention the captain does not have to leave the boat B nor does he require any help to dock the boat B. The mooring hook 10 can be made of a suitable material such as metal or a synthetic plastic or the like.

It will thus be seen that the objects set forth above, among those made apparent from the preceding description are efficiently attained and, since certain changes may be made in the above article, without departing from the scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed is:

1. A mooring hook, which includes:
a telescoping pole having a first end for grasping and second end which is U-shaped serving as a hook, a flange connected to and extending radially inward from said pole toward said U-shaped end and having an eyelet therein, wherein said flange, said telescoping pole and said U-shaped end lie in a common plane;
a clip of a size to permit part thereof to be received through said eyelet;
a mooring line is connected at one end to the clip, a mid portion which includes a loop opening sufficiently large and receiving said telescoping pole therethrough and a second end of said mooring line is free for connection to a cleat of a boat.

2. The mooring hook of claim 1, wherein said telescoping pole is preferably twist locking/releasing.

3. The mooring hook of claim 1, wherein said first end of said telescoping pole has a handle.

4. The mooring hook of claim 1, wherein said a fixed flange is extending radially inward from said second end.

5. A mooring hook, which includes:
a telescoping pole having a first end for grasping and second end which is U-shaped serving as a hook, a flange connected to and extending radially inward from said pole toward said U-shaped end and having an eyelet therein, wherein said flange, said telescoping pole and said U-shaped end lie in a common plane;
a clip of a size to permit part thereof to be received through said eyelet;
a mooring line is connected at one end to the clip; and
a slidable selectable fixable clamp connected to said telescoping pole between said first end and said flange and includes a loop opening sufficiently large and receiving said mooring line therethrough and wherein a second end of said mooring line is free for connection to a cleat of a boat.

6. The mooring hook of claim 5, wherein said telescoping pole is preferably twist locking/releasing.

7. The mooring hook of claim 5, wherein said first end of said telescoping pole has a handle.

8. The mooring hook of claim 5, wherein said a fixed flange is extending radially inward from said second end.
